(19) United States
(12) Patent Application Publication
(10) Pub. No.: US 2010/0149434 A1
(43) Pub. Date: Jun. 17, 2010

(54) MULTIBEAM DIGITAL PROJECTION VIDEO MOTOR HAVING STATIC OR DYNAMIC POINTING CORRECTION WITH OR WITHOUT DEVIATION PERISCOPE

(76) Inventor: Jean-Marc Desaulniers, Binic (FR)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/162,355

(22) PCT Filed: Jan. 25, 2007
(86) PCT No.: PCT/FR2007/000140

§ 371 Date: Nov. 29, 2008

(30) Foreign Application Priority Data
Jan. 26, 2006 (FR) 0600726
Feb. 1, 2006 (FR) 0600902

(51) Int. Cl. H04N 5/64; G03B 21/28

(52) U.S. Cl. 348/744; 353/81; 348/E05.128

(57) ABSTRACT

The invention relates to a device (FIG. 14) making it possible to generate a group of light beams with statically or dynamically controlled pointing adjustment, e.g. with the aid of an optical matrix head feeding the last stage of an item of multibeam digital projection video equipment, comprising a certain number of rotary optical disks. The device comprises a certain number of elements/devices for static adjustments, e.g. of screw plus spring type, or dynamic adjustments, e.g. of micro jack and/or piezo-electric type, carrying out dynamic trim control with the aid of a device, e.g. of pyramidal, conical or other shape, within an optical matrix head. A digital control providing feedback control for the position and lighting of the sources thus makes it possible to create a succession of coloured pixels at the output of the device. According to the desired configurations, several sources may be associated, e.g. within an optical matrix head, to create a matrix of coloured pixels. Depending on the architecture of the video projector used, the optical matrix head devices and integrated optical source modules block are supplemented with an optical deviation periscope. The device is intended for the very top of the range in Digital Cinema and then subsequently for “Home Cinema”.

The present invention relates to a multi-beam scanning digital projection video motor for the 2^{nd} generation Digital Cinema, in order to carry out the projection, for example on wide screen, of a red green blue (RGB) video signal, for example with Ultra High Definition, using, for example, as light source a low/middle power laser within a device generating one or several beams of pixels, supplemented with a device structuring these, for example of matrix, circle, spiral, rose-window, helicoïd shape, etc.

The light beam dynamic pointing adjustment function allows its use in other application fields such as telecommunication (for example point-to-point transmission, point-to-multipoint, guided or in free space, etc).

The projection in theaters is traditionally performed by means of a film projector 35 mm or 70 mm, or 62 mm IMAX type film projectors for integrated projection sites in recreational complexes. A certain number of implementation based on DLP or LCD technology, which achieve enhanced 2K×1K resolution, as well as GLV technology based implementation, allowing that supports 4K×2K pixels resolution, are now available. Using such technologies applied to higher resolution induces exponential costs linked to the development of basic elements (DLP, GLV boxes and LCD matrix). Using microscopic metallic components (DMD micro-mirrors for DLP technology and thin micro-blades for GLV), induces issues of residual magnetic field, of resonance, of early aging (resulting from multiple and repeated torsions), of oxidation, and a limitation in terms of maximal sweeping and/or refreshing frequency to be reach. At LCD level, the main problems are inherent to the usage: 1) of dichroic filters inducing transmission losses and basic components distortion of the color (RGB ratio, gamut and color temperature), at the level of the recombined signal, 2) of LCD shutter matrix having a limited maximal activation/deactivation frequency. These conjugated effects do not ease the optimization process of color mix/temperature/gamut with a sufficient contrast level, required by theaters users.

The application range is high quality Digital Cinema oriented in the first place, then will be re-applied to other market segments (for example “Home cinema”), once the integrating level and industrialization costs have been sufficiently optimized. This existing technologies alternative consists in the use of a light multi-beam digital projection video motor allowing to reproduce a Ultra High Definition (UHD) coloured images sequence, with one or several light sources, following a series of light beams reflections on optical rotating discs. In order to make the image resolution of the multi-beam digital projection motor denser, the aim is to carry out a coloured beam with precision pointing and statically or dynamically controllable trim, to use a certain number of them through an optical matrix head, which structures them, for example in matrix, completed or not with a deviation periscope for screen scanning performed by several beams simultaneously.

The invention principle is the integrating of different modules, or components, of a multi-beam digital video projector.

A basic optical source module allows beam collimation or focusing, monochromatic or not, with a static or dynamic pointing correction.

A coloured beam generator using a certain number of optical source modules completed with a certain number of mirrors and/or filters arranged in order to superimpose or bring collinear several beams from different wavelengths, for example Red, Green and Blue, in a group of parallel beams, contiguous or not, with partial or total overlapping, whose final colour is the sum, in a given point, of each monochromatic components. This module produces a pixel or group of coloured pixels, for example matrix shape structured.

An optical matrix head, which contains a certain number of optical source modules, or coloured pixels generators, placed on a certain number of ring levels having at its centre a device, for example pyramidal shape, allowing, by reflection and/or transmission onto mirrors and/or filters, the realisation of a set of structured collinear beams, for example in a matrix.

Using a periscope in association with the devices described previously permits a significantly size reduction of the device.

The invention is illustrated by the following figures:

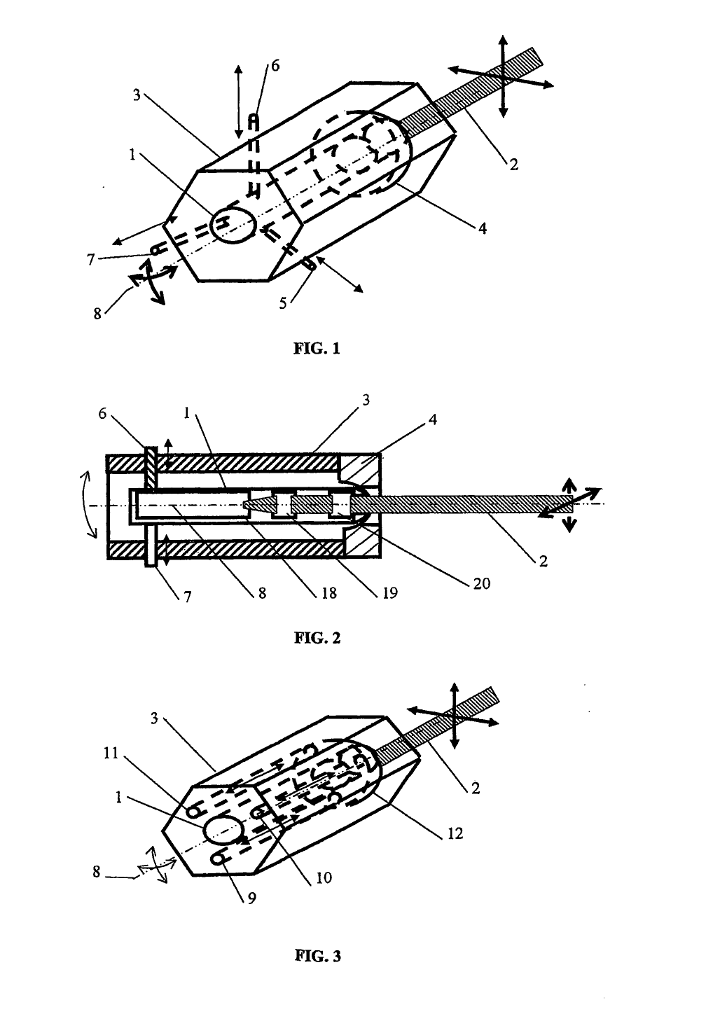

FIG. 1 illustrates, in perspective, the basic optical source module with the adjustment devices (screw, microjack, piezoelectric . . . ) orthogonal to the beam propagation axis.

FIG. 2 illustrates a cross-sectional view of the basic optical source module with the adjustment devices (screw, micro-jack, piezoelectric . . . ) orthogonal to the beam propagation axis.

FIG. 3 illustrates, in perspective, a variant of the basic optical source module with the adjustment devices (screw, micro-jack, piezoelectric . . . ) parallel to the beam propagation axis.

FIG. 4 illustrates a cross-sectional view of the variant of the basic optical source module with the adjustment devices (screw, microjack, piezoelectric . . . ) parallel to the beam propagation axis.

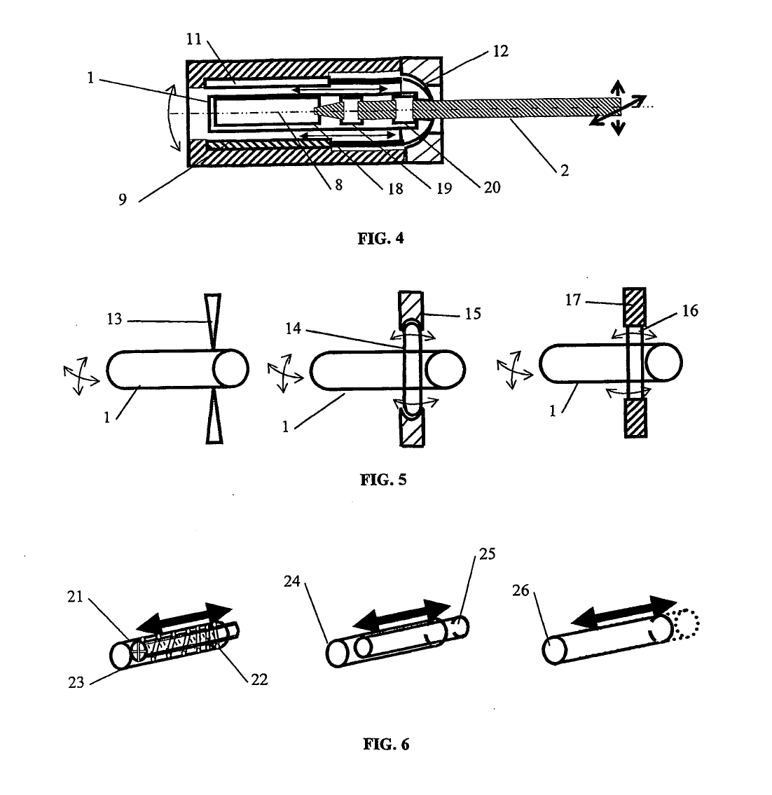

FIG. 5 illustrates a cross-sectional view of different possible solutions for the realisation of a ball joint device (for example arched, mobile, flexible).

FIG. 6 illustrates, in perspective, some devices with screws, micro-jacks, piezoelectric allowing the static or dynamic adjustment of optical source modules.

FIG. 7 illustrates a cross-sectional view of a variant of a compact light source with one or several optical fibers to deport the light generator.

FIG. 8 illustrates, in perspective, different possible architectures of matrix fibers inserted or not in the cannula of the compact optical source device.

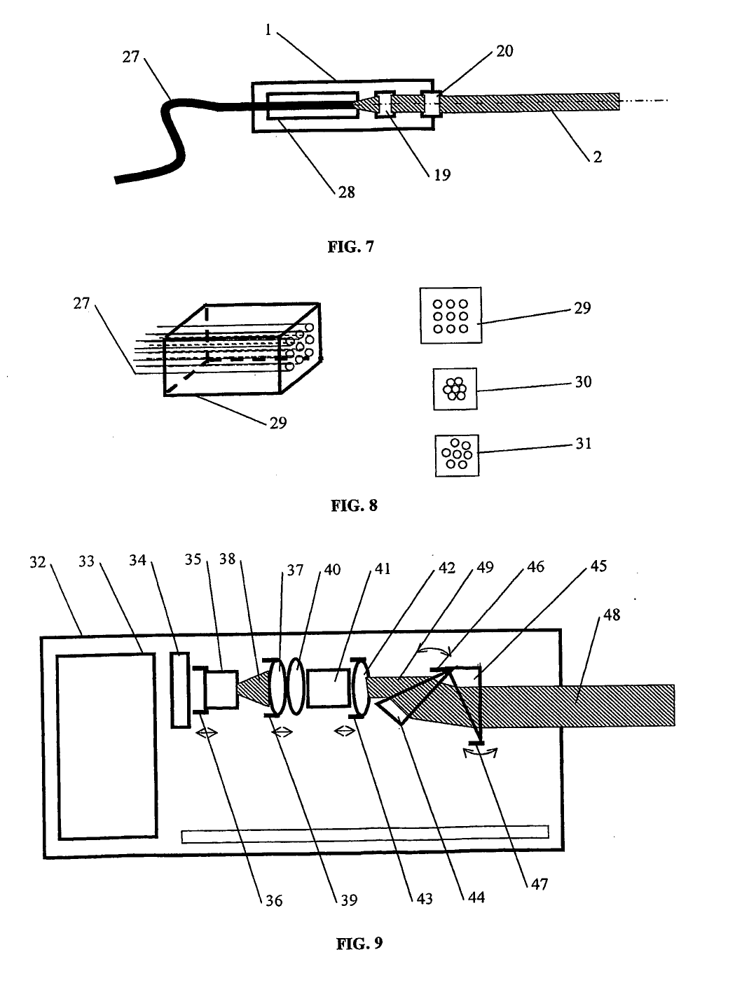

FIG. 9 illustrates a cross-sectional view of a laser source device with a static or dynamic adjustment function.

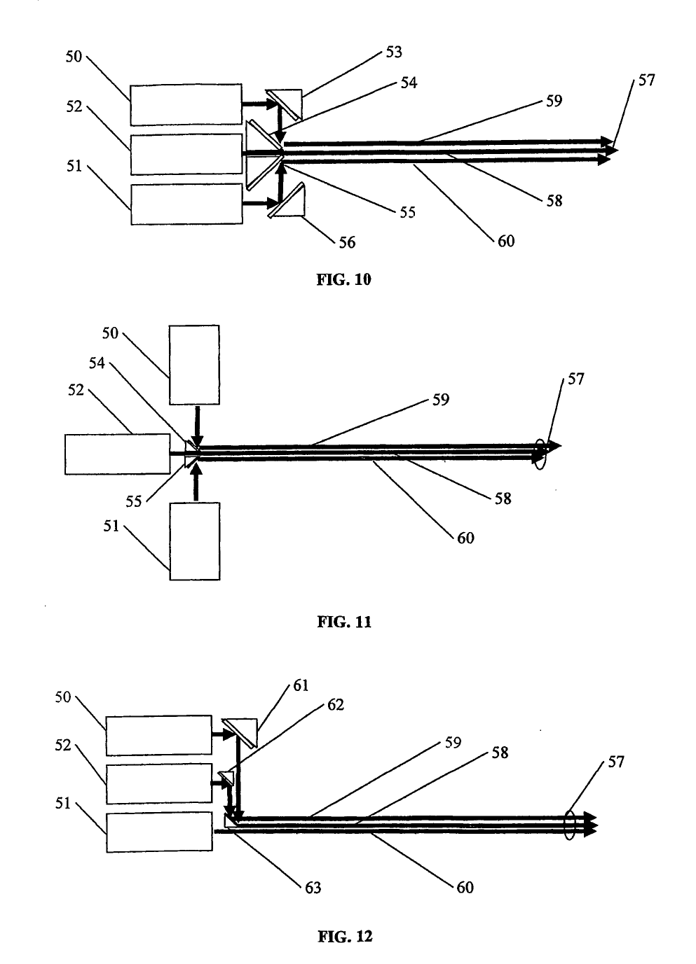

FIG. 10 illustrates a cross-sectional view of a coloured pixels generator with a certain number of basic optical sources modules, for example three, one for each primary colour red, green, and blue.

FIG. 11 illustrates a cross-sectional view of a possible variant of the coloured pixels generator architecture.

FIG. 12 illustrates a cross-sectional view of another possible variant of the coloured pixels generator architecture.

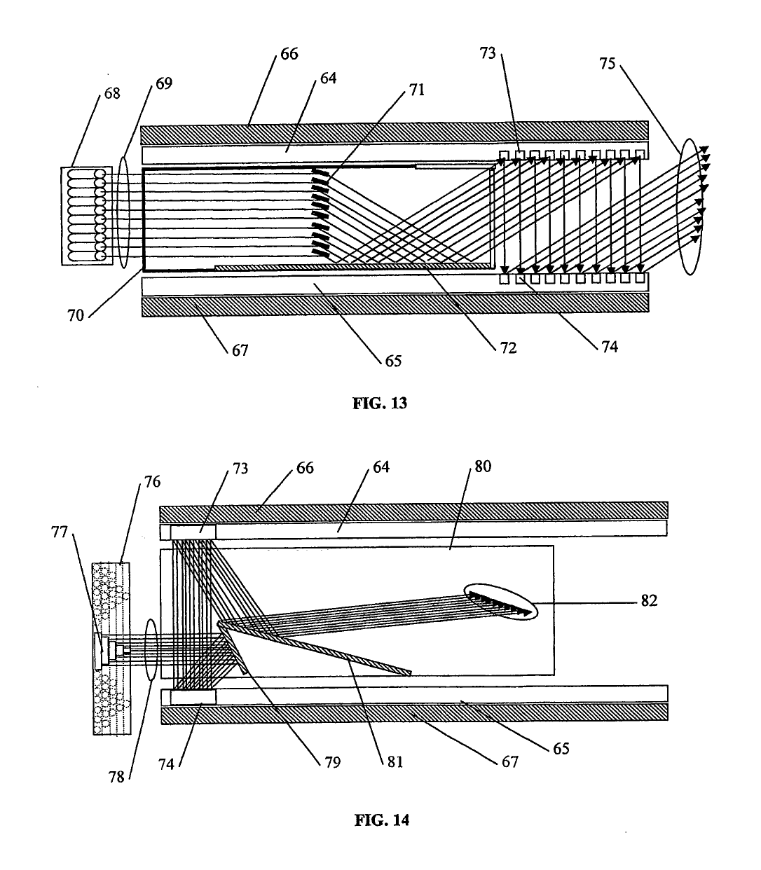

FIG. 13 illustrates a cross-sectional view of the periscope architecture, allowing the deviation of a collateral beams matrix, usable within a digital projection video motor with optical rotating discs.

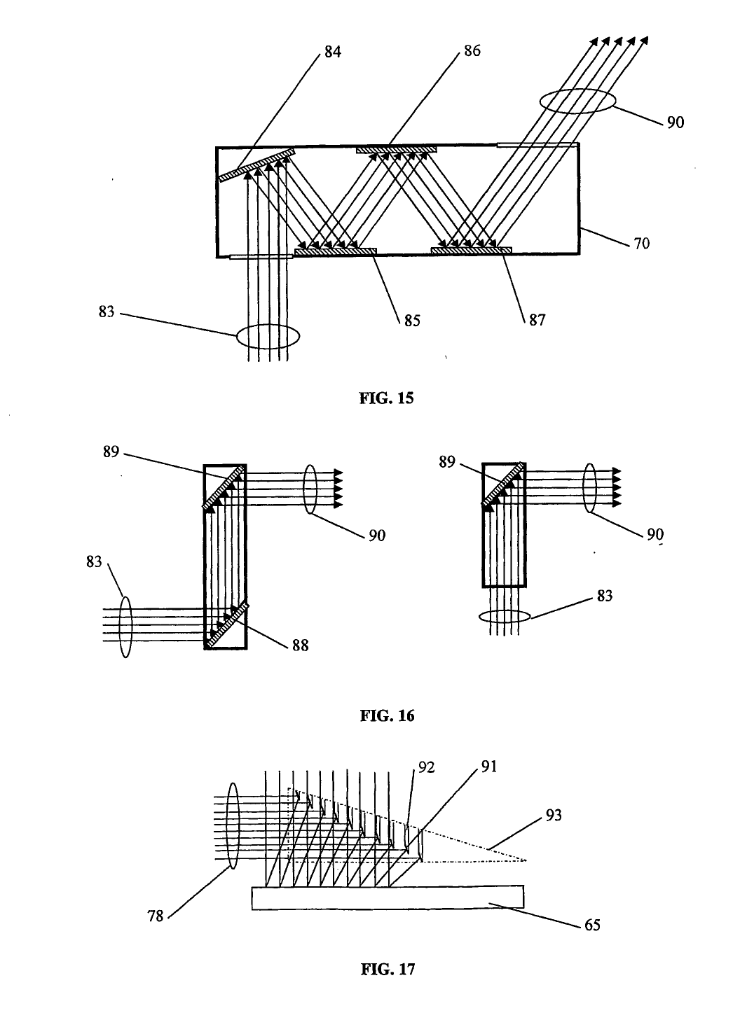

FIG. 14 illustrates a cross-sectional view of a possible variant of the FIG. 13 periscope architecture, with a matrix head for the source of the multi-beam digital projection video motor.

FIG. 15 illustrates a cross-sectional view of another possible variant of the FIGS. 13 and 14 periscope architecture.

FIG. 16 illustrates a cross-sectional view of others possible variants of the FIGS. 13 and 14 periscope architecture.

FIG. 17 illustrates a cross-sectional view of a variant of the first mirror and/or filter of the deviation periscope.

FIG. 18 illustrates, in perspective, a step shape layout of a certain number of source modules.

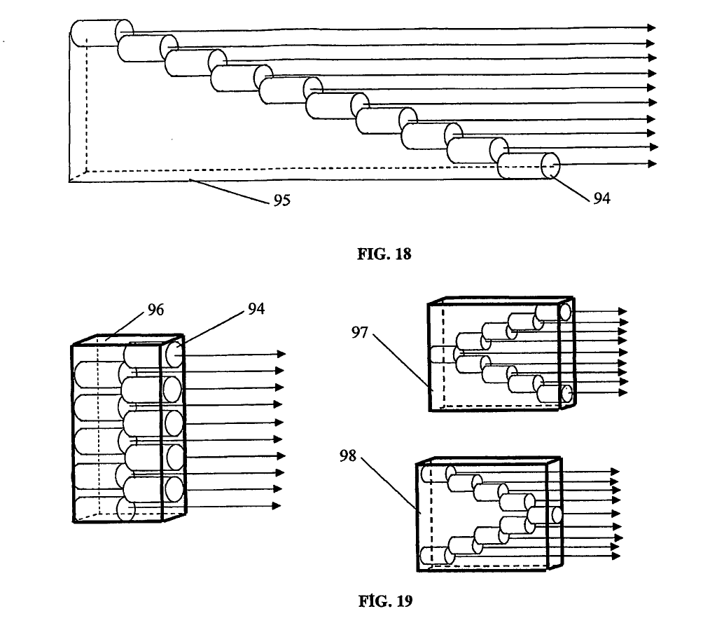

FIG. 19 illustrates, in perspective, layouts in staggered rows, “V” and “inverted V” shape of a certain number of source modules.

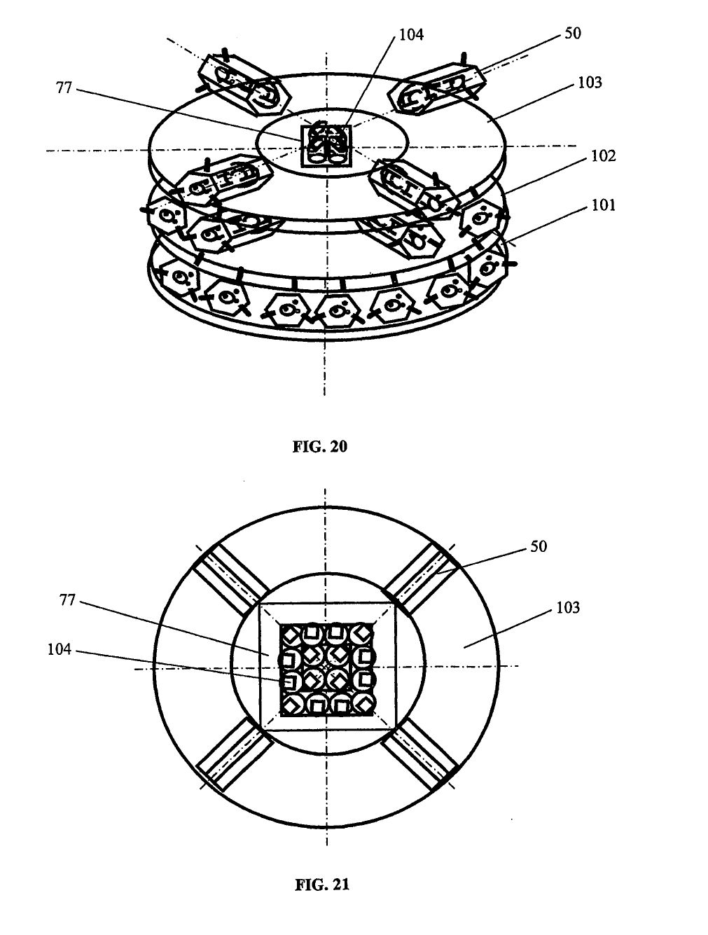

FIG. 20 illustrates, in perspective, an optical matrix head of the beam projection video motor which comprises a pyramidal shape device, support of reflective facets, rings and optical source modules.

FIG. 21 illustrates an upper view of the optical matrix head first level, of the beam projection video motor, which comprises a pyramidal shape device, support of reflective facets, rings and optical source modules.

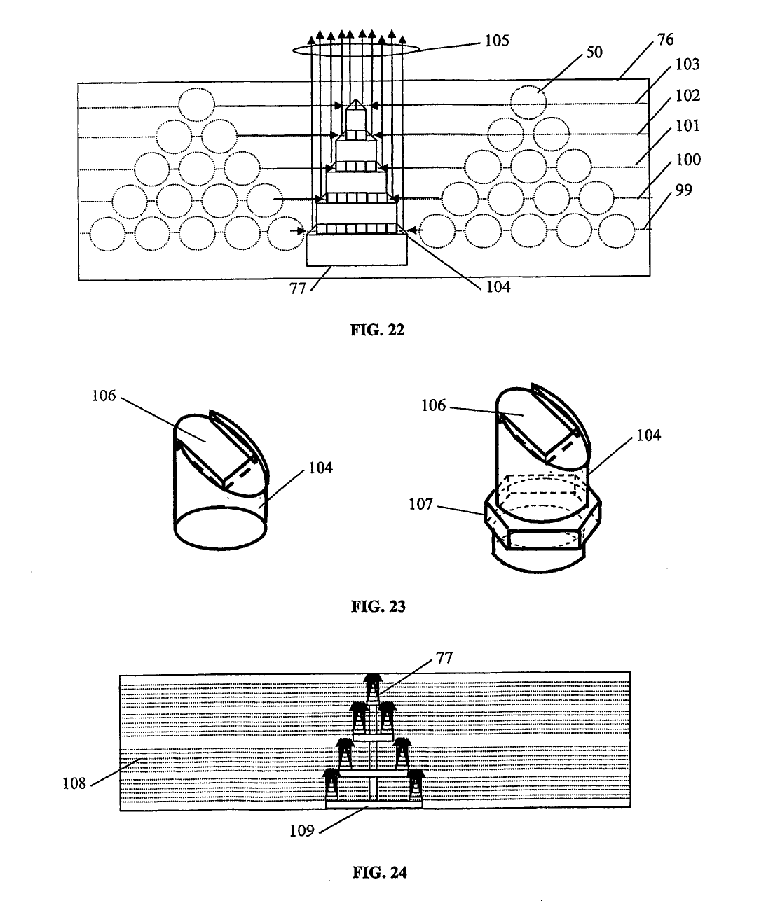

FIG. 22 illustrates a cross-sectional view of an optical matrix head of the beam projection video motor which comprises a pyramidal shape device, support of reflective facets, rings and optical source modules.

FIG. 23 illustrates, in perspective, the reflective facets support for the FIG. 20 matrix head.

FIG. 24 illustrates a cross-sectional view of a variant of the optical matrix head for multi-beam digital video projector, which comprises several deviation periscopes.

FIG. 25 illustrates a simplified cross-sectional view of several possible arrangements for pyramids represented in FIG. 22.

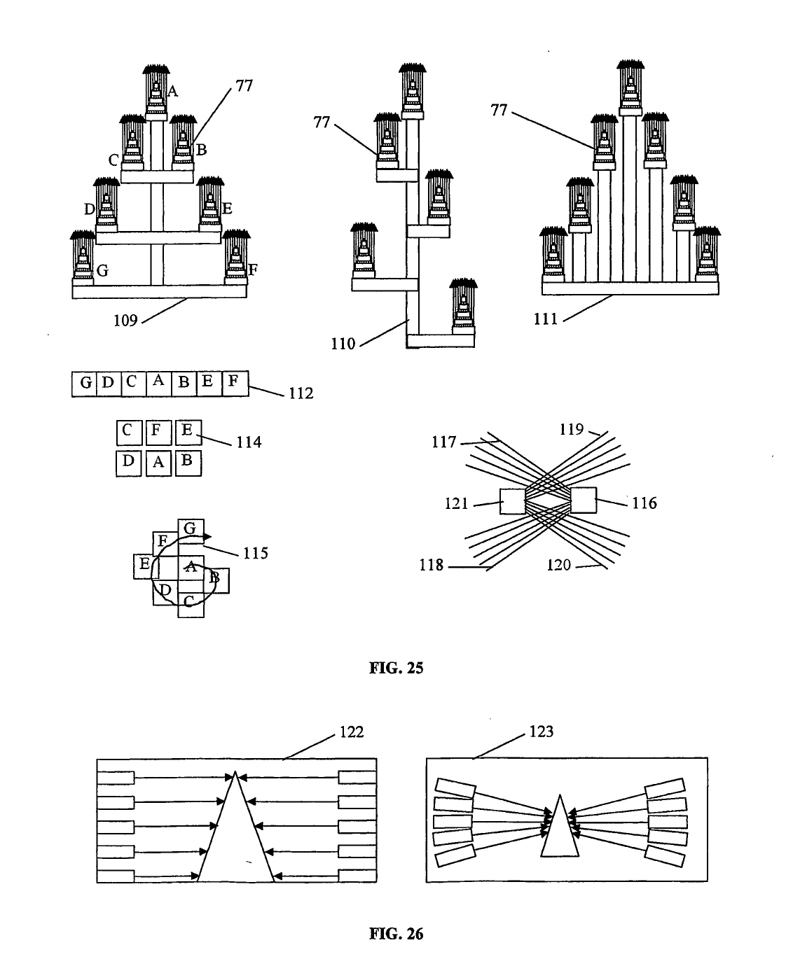

FIG. 26 illustrates a cross-sectional view of the possible source modules orientation for the matrix head.

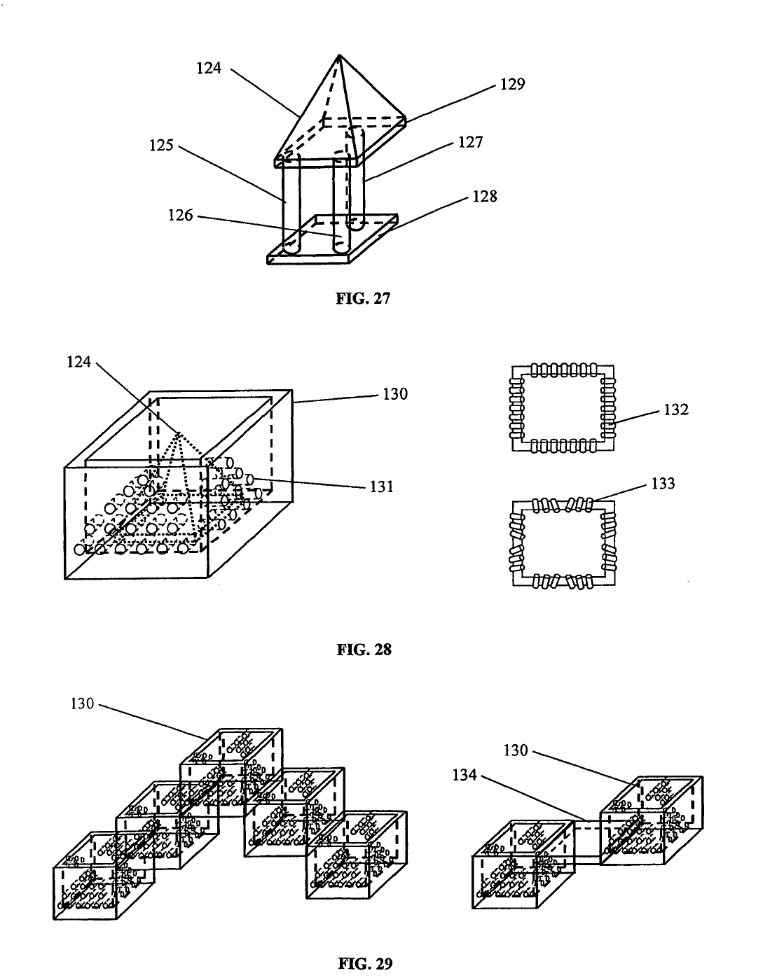

FIG. 27 illustrates, in perspective, a trim control device comprising screw, micro-jack, piezoelectric, etc, which can be adapted on different elements of a multi-beam digital projection video equipment.

FIG. 28 illustrates, in perspective, and a cross-sectional section view of a pyramid matrix head protection device for digital projection video.

FIG. 29 illustrates, in perspective, several assembling examples of the FIG. 26 pyramid matrix head protection device.

FIG. 30 illustrates, in exploded view, the possible constituent parts of an optical rotating disc for multi-beam digital projection video, comprising sectors, tracks, arrays and cavities.

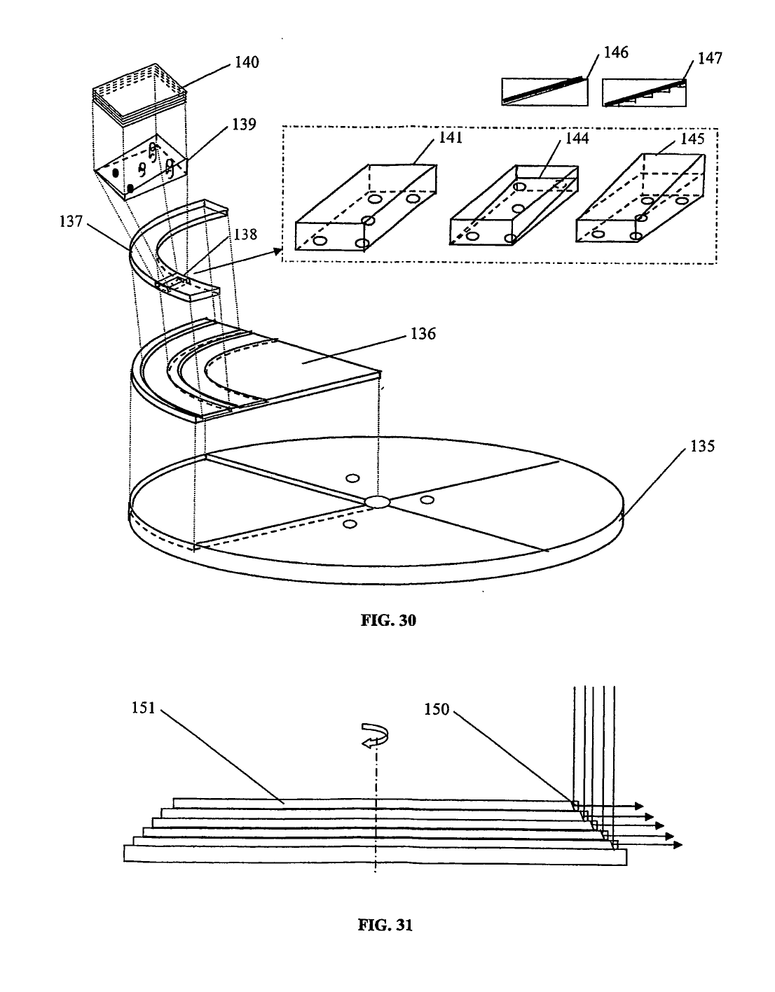

FIG. 31 illustrates a cross-sectional view of an optical rotating disc with each track having a different height.

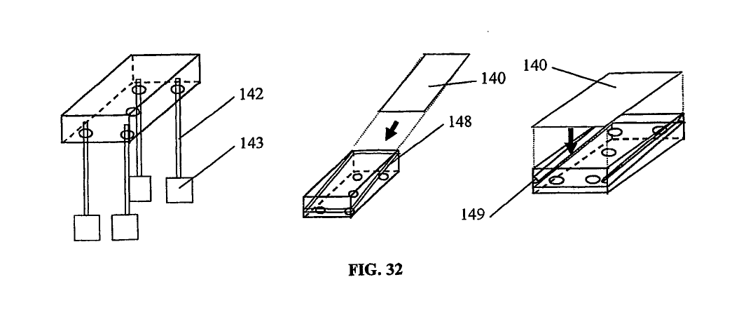

FIG. 32 illustrates, in perspective, a facets orientation adjustment device in a cavity and different retaining means in this cavity.

### OPTICAL SOURCE MODULE

As a reference to the drawings, the optical source module device, in perspective (FIG. 1) and cross-sectional view (FIG. 2), comprises an optical source inside a cannula (1) producing a light beam (2), a box (3), for example of hexagonal shape, used as a support of ball-joint device (4), completed with three adjustment devices (5), (6) and (7), placed perpendicularly to the propagation axis (8). The ball-joint device (4) is accomplished, for example at the cannula end (1) with a head or a spherical connector, pierced in its centre to let the beam pass (2), put in a partially spherical cavity slightly larger, pierced too in its centre to let the beam pass (2). Each of these adjustment devices (5), (6) and (7) causes a translation motion behind the cannula, then the motions combining causes a two axes motion to the cannula (1). This two axes rotational motion passed to the cannula (1) causes a light beam (2) propagation axis (8) modification.

Depending on size and/or implementation constraints, a second adjustment devices implementation (5), (6) and (7), in the axis of the cannula (1) is possible, which is illustrated in perspective (FIG. 3) and cross-sectional view (FIG. 4), with devices (9), (10) and (11). The two axes rotational motion is then transmitted by means of a ball-joint (12) consisting for example of two spherical elements: the first one at the cannula extremity (1), the other one in the support. These two spherical elements being perforated at the centre to let the light beam pass (2).

Several rotation devices variants (FIG. 5), or ball-joint, may be used in the source module. This one, at the extremity or around the cannula (1) may be, for example, a bending (13), a rounded ring (14) in a support (15), or a flexible ring (16) in a rigid support (17).

The cannula (1) integrating optical source (18), for example laser diode, light-emitting diode, optical fiber etc, may contain, according to configurations, a certain number of optical elements, for example two lens (19) and (20), achieving the emerging beam (2) focalisation or collimation in the longitudinal axis direction of the cannula (1). Thus each cannula motion passes on the light beam propagation axis direction.

The correction devices (FIG. 6) used in source modules are, according to the targeted application, to the required precision and modification speed, screw (21) plus spring type (22) in a small cannula (23), micro-jacks (24) and (25), or piezoelectric modules (23) having lengthen property under an electric field influence.

According to the size constraints, or the different optical sources availabilities at targeted wavelengths, optical source modules (FIG. 7) may be composed of an optical fiber (27) in a positioning ferule (28) inserted in the cannula (1) allowing to reduce its size by deporting the source. If necessary, a focalisation or collimation device (19) and (20) will reform the divergent beam in fiber breakout. Every focalisation solution in optical fiber breakout is usable in this case.

It may be used too (FIG. 8) in cannulas integrating the source, an optical fibers bundle (27) structured in matrix shape for example squared, rectangular (29) or circular (30). The optical fibers, or matrix, are completed or not with focalisation optic in fiber breakout. In the case of an optical fibers bundle use, they will be stuck (30) together or shared out (31) in an equidistant way or not.

Another possible realisation mode is the integration, in the cannula, of a laser source with dynamic adjustment function (FIG. 9), including inside its box (32): an electronic control module (33); a temperature control device (34) for example Peltier type; a laser diode (35) mounted on a correction device (36) of screw, micro-jack, piezoelectric type . . . ; of a collimation optic (37), of the beam (38), mounted on a correction device (39) of screw, micro-jack, piezoelectric type . . . ; a modification device (40), (41) and (42) of one or several combinations of beam physical characteristics, for example wavelength doubling, with a doubling crystal (41) and a coupling lens, in input (40) and in output (42), mounted on a correction device (43), for example screw, micro-jack, piezoelectric type; a couple of prisms (44) and (45) mounted on correction devices (46), (47), for example screw, micro-jack, piezoelectric type . . . allowing a dynamic adjustment of beam ellipticity (48) by beam extension along one axis.

Coloured Pixel Beam Generator:

Association of several optical source modules (FIG. 10) producing a beam with different colours, for example Red (50), Green (51) and Blue (52), and several mirrors and/or filters, for example (53), (54), (55) and (56) permits the creation of a coloured beam source module with a series of successive reflections. Among the possible realisation modes, a first source module (52) generates directly a beam (58) toward the target point (57), this beam then represents the main propagation axis of the colour beam generator. A second source module (50), placed above and in the same way to the first one (52), generates a collinear beam (59), superimposed or not with the beam (58), through a first reflection on the mirror or filter (53). This one moves the beam (59) perpendicularly to the main axis direction. A second reflection onto a mirror or filter (54) then reflects the beam to the main axis direction (58). A third source module (51), placed below and parallel to the first one (52), produces a collinear beam (60), superimposed or not with the beam (58). Through a first reflection on the mirror or filter (56), beam (60) is moved perpendicularly toward the main axis, then a second reflection on a mirror or filter (55) then reflects the beam in the major propagation axis direction.

According to the realisation and size constraints, the coloured beam generator architecture may change as shown for example (FIG. 11) and (FIG. 12), where the three optical source modules (50), (51) and (52), are on the same plan (FIG. 11) but placed according to an angle, for example 90°. The two mirrors or filters (54) and (55), placed according to an angle, for example 45°, allow to reflect the three beams (58), (59) and (60) in the same direction toward the target (57). In the case of (FIG. 12), the three source modules (50), (51) and (52) are superimposed but use only three mirrors or filters (61), (62) and (63) to make the beams (58), (59) and (60) collinear or slightly divergent.

The mirrors and/or filters used may be passive type; for example metallic thin layer deposit, or active type, that is, allowing to reflect the beam by modifying one or several of these physical characteristics, for example its geometry by means of a DLP matrix. The coloured beams generators mirrors and/or filters set will be constituted of, for example reflective LCD, micro-layers, micro-mirrors or every other active device allowing beam deflection.

In the same manner, the mirrors and/or filters of the coloured beam generator could be mounted on screw/micro-jack/piezoelectric type dynamic correction devices enabling to achieve a dynamic trim control of the different beams of the module.

Periscope:

In a multi-beam digital projection video motor (FIG. 13), for performance and size reducing reasons, it is possible to reduce the space between two discs (64) and (65) on their respective supports (66) and (67). In the same manner, it may be judicious to multiply and structure the sources number to illuminate for example the different sectors.

A possible implementation of the multi-beam digital projection video motor is to use a source array (68), composed for example of a certain number of source modules, allowing to produce a comb of a certain number of collinear beams (69). This source comb attacks the first optical rotating disc (64) through a deviation periscope (70) composed of a certain number of mirrors and/or filters (71) and a folding mirror and/or filter (72). In this architecture type, the beam from a source is in a first time reflected by a first mirror and/or filter (71), then it undergoes a reflection on a folding mirror and/or filter (72), allowing to extend the optical path in a limited size, then arrives on the reflective facet (73) of the first optical rotating disc. The light beam is then reflected with a vertical angle set by the mirror and/or filter orientation (73) then reflected by the facet of the second disc (65) imposing a horizontal deviation angle in output (75).

A possible variant (FIG. 14) of the previous architecture is to replace a source module by a matrix head (76) generating, with a pyramidal shape device (77), a collinear light beams matrix (78) on the primary mirror and/or filter (79) of a deviation periscope (80), then in order: the reflective facet of the first disc (65), the second disc facet (73) and the periscope (80) secondary mirror and/or filter (81). At a “t” time, all input matrix beams (78) undergo the same vertical and horizontal deviations without modifying their output collinearity (82).

Others periscopes variants are possible, (FIG. 15) and (FIG. 16), allowing to change the propagation direction of a collinear beams matrix (83) aid of a certain number of mirrors and/or filters (84), (85), (86), (87), (88) and (89). Output beams (90) stay collinear after the periscope.

A more compact variant (FIG. 17) of the periscope input mirror and/or filter permits to limit the space between the two discs and restricts the light beams path. The primary mirror and/or filter is achieved with a certain number a small-size mirrors and/or filters (91) positioned on regularly spaced supports (92). A support device (93) maintains them in a stair-step structure. Each beam from the beams set is thus deflected by a mirror and/or filter (91) toward the first disc facets, which points it vertically toward the second disc. The spacing between the small mirrors and/or filters (91) allows beam transit between the two discs.

In order to achieve a static or dynamic adjustment, the periscope mirrors and/or filters set will be mounted on screw/micro-jack/piezoelectric type correction devices or any else controlled dynamic correction device.

In order to simply achieve the addressing, for example of the different optical rotating discs sectors while reducing the space between them, a periscope powered by a certain number of sources is used. Different sources assembling are possible according to the configurations: for example stair-step (FIG. 18), where each source module (94) is positioned on a support (95) comprising steps for space reduction between different beams, leading to a gain in height on the size of the source modules set. There is also other alternative (FIG. 19) through source modules implantation according to another geometry, for example in staggered rows (96), “V” shape (97) or “inverted V” shape (98), thus reducing the source modules block depth.

The source blocks will, if the technology permits a sufficient integrating, be equipped of a source module, a coloured beam generator or a multi-beam digital video projector matrix head.

Optical Matrix Head:

The multi-beam digital video projector matrix head (FIG. 20), (FIG. 21) and (FIG. 22) is composed of a certain number of rings, for example (99), (100), (101), (102) and (103), where a certain number of source modules (50) or coloured beam generators modules is positioned on each ring. These devices direct the beams toward mirrors and/or filters (104) placed at the rings centre onto a support (77) for example pyramidal, conical or other shape, and structure beams in order to bring them collinear and to obtain an output matrix (105).

The mirrors and/or filters supports (FIG. 23), components of the matrix head central device are, for example cylinder-shaped (104) slanted truncated according to a certain angle, for example 45°, with a small cavity (106) for insertion of a small-size mirror and/or filter. If necessary, the support will have a hexagonal perimeter (107) facilitating the positioning and the adjustment with a specific tool.

Instead of a single source (FIG. 24) or pyramid (77), a set of pyramids may be inserted at the rings centre (108) through a shaft (109) in order to increase the resolution and/or reduce the multi-beam digital projection video motor mechanical constraints.

Several pyramids implantations types on shafts are possible (FIG. 25). For example “Christmas tree” shape, where the pyramids are maintained by a solid support or composed of very thin rigid stems support (109). The considered solutions are not necessary symmetric (110) or linked to the base (111).

For these implantations, it must be taken into consideration dimension constraints and beams number arriving on pyramidal elements, which will be placed on a same plan, for example linear (112), or shared out in space, for example (114) or (115). Indeed, according to the pyramid size, and beams number incoming onto the reflective facets opposite each other of two pyramids placed at the same level, for example (116) and (121), the space between the two elements must let pass, with a not too important angle, the beams group (117), (118) for the pyramid (116) and (119), (120) for the pyramid (121). To avoid this problem, the pyramids will take place on different levels and/or shared out into space evenly. The aim is to obtain a parallel beams matrix evenly shared out at the output. It is thus possible to obtain (FIG. 25) a 3D architecture (114) where each uppercase represents a pyramidal element. Through this embodiment, two pyramids, for example noted C and B, are on a same level but not having faces in vis-á-vis. A spiral shape distribution solution (115) avoids addressing problems too.

The source modules implantation on matrix head rings for multi-beam digital video projector may be organized in different ways (FIG. 26) according to size constraints and/or the central pyramidal device size and shape. If the source modules size and the height difference between the reflective facets of the pyramid are identical, each ring is placed in order that the beams coming from the source modules are in the same plan as the pyramid level (122). Another possibility is that source modules of a ring address a pyramid element to a superior or inferior level (123).

It may be necessary for stability raisons, or for dynamic corrections aims, to use on the pyramid a support integrating a trim control (FIG. 27). This trim control device, for example of the pyramid (124), is composed for example of three elements (125), (126), (127) screw, micro-jack, piezoelectric type . . . placed according to an isosceles triangle between a lower platform (128) and a pyramid carriage upper platform (129). The fast electronic control of the three devices imposes a very slight trim correction.

The size of the pyramidal device placed at the centre of the optical matrix head rings for multi-beam digital video projector being quite little, it is possible to place it inside a protection device (FIG. 28). The latter is for example a hollow cube (130) built in transparent material or having strictly directed holes (131) according to incident beams propagation axe on each pyramid facet (124), for example strictly parallel (132) or with an angle (133).

These different protection cubes may be used to build the pyramids <<trees >> (FIG. 29) with an additional support device or not.

Optical Rotating Discs:

According to achievement variants, optical rotating discs of the multi-beams digital projection video motor will consist of a certain number of elements or “snap-on” devices and/or connected to each other. For example (FIG. 30) the disc (135) is composed of four sections (136) themselves composed of two sectors (137) wherein is realised a certain number of cavities (138) integrating supports (139), or wedges, pointing the mirrors/filters (140) composed, for example, of a substrate and a metallic layers and protection layers stack.

The cavities (138) are, according to the means of fabrication, plane (141) with a certain number of holes allowing (FIG. 32), by means of needles (142), mounted on micrometric translation stages (143), to direct the mirrors/filters before to be sealed for example with industrial glue.

Another possibility to direct the reflective facets in the cavities is to perform an inclined plane into the device (144) or onto the surface (145) directly during the disc achievement, for example by lithography process. According to the achievement accuracy, the slopes will be smooth (146) or step shaped (147). The reflective facet is then immobilized by gluing process, for example by resin injection inside the holes at cavity bottom.

Another facets positioning achievement variant (FIG. 32) is the use of slits in the cavity slices (148). The facet (140) is then positioned by shifting in these slits whose size is fitted to the facet thickness setting a specific orientation, then an embedding is achieved to avoid any movement.

According to the same principle, a positioning of the facet will be achieved by “snap-on” onto grooves (149) themselves achieved with certain softness around the cavity. The facet (140) is then pushed in the cavity bottom setting its orientation.

According to the applications and/or the beams power used on the mirrors/filters, it may be necessary to clean and regenerate the reflective surface (140). This one may be performed, for example with a stack of a certain number of reflective layers and protection layers. When the reflective surface is too soiled or distorted, a cleaning process, for example a chemical reaction or a pulsed laser, eliminates the protection layer to uncover the inferior reflective layer. This automatic repairing process allows showing an oriented surface as the first one avoiding thus a costly maintenance on the optical rotating disc for multi-beam digital projection video motor.

A disc variant (FIG. 31) is envisaged wherein the different reflective facets sectors (150), composed or not of arrays (137), sections (136), are at different heights (151). The disc will then be addressed by the slice.

The disc positioning onto the motors may be achieved for example with three holes shared out for example at 120°, along with a central hole in order to maintain it on the motor shaft.

The application range of this system will be targeting in first place video projection domain for 2^{nd} generation Digital Cinema.

1. A multi-beam digital projection video motor device characterized by a certain number of superimposed optical rotating discs, comprising themselves a determined mirrors and/or filters layout, causing the deviation of a parallel incident beams set from, for example, an emission block constituted of a certain number of sources modules and/or a certain number of matrix heads, comprising a certain number of optical sources modules, coloured beams generators or deflection pyramids, said deflection being oriented for example vertically by the first optical rotating disc and horizontally by the second, and comprising in addition a deflection optical periscope device with two mirrors and/or filters constituting a reflective prism, or, according to the configurations, a certain number of mirrors and/or filters, for example (71) and (72), allowing to attack the first disc with a predetermined angle introducing a low obstruction.

2. A device according to claim 1 characterized by an optical matrix head upstream, comprising itself a certain number of ring levels on which are positioned, to avoid beams intersections, a certain number of optical source modules pointed towards the centre of each ring, in order to deflect each beam towards mirrors or filters, themselves regularly placed on a support central device or sculptured in the support, said support having a pyramid, cone or other shape, on which each mirror or filter is pointed to guarantee the colinearity of the beams at the device output.

3. A device according to claim 2 characterized by a mirrors and/or filters support, said support is, for example cylinder shape, bias truncated according to a determined angle, in order to point specifically each incident beam, the truncated side comprising a cavity adjusted to the mirror and/or filter size, the said support may have, as a variant, a hexagonal element inserted under the base to ease the orientation in the production and adjustment line.

4. A device according to claim 2 characterized by a central pyramid-shaped device of the optical matrix head for multi-beam digital video projector, which comprises a layout of several deviation pyramids, allowing to make the beams from this optical matrix head denser, the said pyramids being fixed, according to the variants, aid of a shaft for example (109), (110), (111) composed of very thin stems, plane or not, rigid, allowing to avoid the obstruction of the passage of the light beams coming from a ring of the optical matrix head.

5. A device according to claim 2 characterized by optical source modules shared out on each ring of the optical matrix head associated to a multi-beam digital projection video motor, address the same level or a certain number of different levels of the deviation pyramid optimizing thus the optical matrix head obstruction.

6. A device according to claim 2 characterized by optical matrix head for multi-beam digital video projector comprising a trim correction mechanism, inserted behind this one or below the central pyramid or any other element according to the optical matrix head configurations, composed of a certain number of devices, screw, micro-jack, piezoelectric type, or any other element allowing to achieve a controlled translation, disposed between a lower platform and a an upper platform, allowing to point beams requiring a dynamic trim correction.

7. A device according to claim 2 characterized by the pyramid-shaped element of the optical matrix head for multi-beam digital video projector which is protected by transparent or perforated walls, which allow the passage of beams from the source modules towards the device mirrors or filters, where a certain number of protection devices allows them to be stacked together to compose the pyramids arborescence according to claim 9 with or without the help of an intermediate plate.

8. A device according to claim 1 characterized by optical rotating discs for multi-beam digital projection video motor, each said disc comprises reflective facet insertion cavities and, in its centre, a certain number of binding holes, laid at 120°, with or not a central positioning hole, the said hole may be composed of a certain number of sectors, movable or not, themselves composed of a certain number of arrays or arches, movable or not, on which is achieved a certain number of cavities, which comprise themselves a certain number of holes through the different disc components, to adjust or seal the mirrors or filters, and which allow to insert the reflective facets in direct contact with or by means of facet gate, which, according to the disc variants, are pointed according to angles imposed by the bottom of the cavities engraved in the device, or on surface, determined by a plane or a series of steps, and/or determined by means of a support inserted in the cavity. The different sectors and/or arrays can be embedded the ones in the others, or superimposed, allowing to point the incident and/or emergent light beams on the track edge.

9. A device according to claim 1 characterized by mirrors and/or filters reflective surface placed on a substrate by a stack of a certain number of metallic and protection layers, which may be removed individually by a chemical process, laser, ultrasonic sound or other, to have a clean surface again, which introduced an automatic or not surface repairing function, where a variant will be the use of “active” reflective surface such as DLP, LCD or any other adaptive optical process allowing to vary some characteristics of the reflective beam such as for example the light intensity, the shape, allowing for example a geometric adaptation of the beam.

10. A device according to claim 8 characterized by a reflective facets positioning system (140), achieved according to the possible configurations, by means of runners (148) and/or by a “snap-on” device (149), or through a certain number of positioning devices, crossing over or not inside the disc, automated or not, for example hollow or full needles (142), or pneumatic plungers, or electric magnets, fixed on micrometrics translation stages, whose height adjustment fixes a specific angular orientation of each facet, which then is sealed, for example by a gluing process.

11. A device according to claim 1 characterized by optical source module, integrated or not in the optical matrix head which ensures the focalization, the collimation and the colinearity of the beams, having each one a cannula with one or several optical sources, which generate one or several collimated beams, or with a very low divergence, these sources being for example ultra light-emitting diodes, laser diodes, or any other light source type of small size, fiber or not, integrated in a device, for example hexagonal-shaped, serving as support in the front for a pivot or ball-joint point, and in the back for a device allowing a positioning adjustment on the two axes perpendicular to the propagation axis of the light beam, through a certain number of correction devices, for example three, achieving a translation motion.

12. A device according to claim 1 characterized by positioning correction devices of the optical source module, said devices are aligned according to the optical source module axis and not perpendicularly to this module.

13. A device according to claim 11 characterized by an optical module source which pivot or ball-joint point is arched support, rounded ring pivoting inside a rounded cage, ring made of soft material in a rigid support or any other device allowing the cannula, mobile around the two axes perpendicular to the optical source module axis, to revolve slightly with respect to this module.

14. A device according to claim 11 characterized by correction devices of the optical source module, allowing the light beam propagation axis orientation, having static, for example screw plus spring type, or dynamic adjustments, for example of micro-jack and/or piezoelectric type, or any other device allowing to achieve a dynamic controlled translation.

15. A device according to claim 1 characterized by cannula from the optical source module that may fit for one or several optical sources, monochromatic or not, each composed for example of a laser, a fiber or not light-emitting diode, completed with a series of lens, or any other optical device allowing the static or dynamic beam focalization, with screw, micro-jack or piezoelectric elements. In the case for example of a fiber source, this one is structured in optical fibers matrix, contiguous or not, with any layout or a structured layout, for example with matrix, circle, spiral, rosaceous, helical shape, etc.

16. A device, according to claim 1 characterized by optical source module integrating laser source with a dynamic adjustment function composed of a laser diode, a collimation device, a beam generating device comprising a wavelength shift device or not, which is, according to the applications, replaced or completed with a light intensity modulation device, for example with a non linear crystal, a polarizer or any other device acting on one or several physical characteristics of the light beam, and characterized too by certain number of dynamic devices of this source for example micro-jack, piezoelectric type, etc, allowing to vary the geometric characteristics, for example size, ellipticity, power, and so on, of the output module beam, by means of a quick electronic command.

17. A device according to claim 1 characterized by a certain number of optical sources modules devices, for example (50), (51) and (52), dedicated to the coloured beam generation of the optical matrix head or the multi-beam digital projection video motor, having a different emission wavelength, for example red, green and blue, and a certain number of mirrors and/or filters allowing the recombination of a certain number of distinct beams into a set of a certain number of parallel beams superimposed or very close to each other whose resulting is a coloured beam whose spectrum depends on the proportion of the light intensity and the wavelength of each beam, where the direction of the beam coming from a coloured beam generator being statically or dynamically controlled with a certain number of devices, for example screw, micro-jack, piezoelectric cells, or any other element allowing a low modification of the different mirrors or filters orientation of the device, a possible variant of which being the use of one or several classical recombining cubes instead of mirrors or filters.

18. A device according to claim 1 characterized by a deviation periscope of a certain number of parallel light beams from an optical matrix head, or a certain number of optical sources modules, having a cockpit or protection cell, parallelepiped shaped, cylinder-shaped, hollow or engraved in a transparent material for the desired wavelengths, completed with a certain number of mirrors or filters, for example (84), (85), (86), (87), (88) and (89), allowing by a series of reflections and transmissions to modify the propagation direction orientation of a certain number of parallel light beams without modifying their collinearity, the input deviation periscope mirror or filter being achieved for example with a certain number of small mirrors or filters on supports maintained by a major support, for example stairs-step shaped, and mounted on dynamic correction elements as screw, micro-jacks, piezoelectric type, etc.

19. A device according to claim 1 characterized by a particular layout of optical source modules allowing to produce a set of collinear beams in a reduced volume, without modification of beams characteristics or intrinsic properties, said layout of sources modules is, according to the variants, build as stairs-step shape, in staggered rows, “V” shape, or any other geometric layout allowing to obtain a certain number of collinear beams regularly spaced in a reduced volume.
